(19) United States
(12) Patent Application Publication
(10) Pub. No.: US 2013/0337742 A1
(43) Pub. Date: Dec. 19, 2013

(54) METHOD FOR SELECTING ONE OF N CONTACTLESS ELECTRONIC DEVICES

(71) Applicants: Christophe Arnoux, Auriol (FR); Jean-Luc Meridiano, Tourves (FR)

(72) Inventors: Christophe Arnoux, Auriol (FR); Jean-Luc Meridiano, Tourves (FR)

(73) Assignee: Gemalto SA, Meudon (FR)

(21) Appl. No.: 13/991,632

(22) PCT Filed: Nov. 29, 2011
(86) PCT No.: PCT/EP2011/071308

§ 371 Date: Aug. 20, 2013

(30) Foreign Application Priority Data
Dec. 6, 2010 (EP) 10306355.8

(51) Int. Cl. H04W 76/02

(52) U.S. Cl. CPC H04W 76/023
USPC 455/39

(57) ABSTRACT

The invention relates to a method for selecting one of a plurality of contactless electronic devices by means of a voluntary action of the user in accordance with a display of visual information, said visual information being from each of the contactless electronic devices. The invention also relates to a contactless terminal capable of implementing said method.

The invention concerns a method for selecting one among N contactless electronic devices.

The invention relates in particular to the selection, by the user, of a contactless electronic device by means of a visual identification of each of them.

The number and variety of contactless electronic devices is in constant evolution. At the present time, the great majority of persons possess several such devices.

We will focus on a certain type of them: passive contactless devices.

These devices have the main feature of receiving their energy from the contactless reader with which they are in the process of dialoguing. They all contain at a minimum an antenna and an electronic component.

Among these devices, we shall cite for example electronic identity documents such as passports, identity cards, driving licences, etc., chip cards such as electronic purses, and also tags.

Tags are labels, in particular used as an anti-theft device in some shops.

All these devices, which we shall group together under the term passive contactless devices (PCDs), have in common the following operating cycle:
entry of the PCD into the electromagnetic field of a contactless reader
reception of energy via said electromagnetic field
starting up of the component
establishment of a connection between the reader and the PCD
launching of the program or programs present on the PCD.

A concern arises in the case several PCDs come at the same time into the field of action of the same reader.

Numerous so-called “anti-collision” solutions enable the reader to distinguish the various PCDs. However, one problem remains in full: the choice of the PCD that must be used and the program of which must be launched. This choice is all the more crucial for the bearer of all or some of the PCDs. This is because, if several contactless credit cards or electronic purses enter the same field, it is important for the bearer to be certain of the card or purse that will make the transaction.

The present invention solves this problem by requiring, when the communication channel is open between each of the PCDs and the reader, a visual information that will be submitted to the user, and it is only after the selection of one of visual information items that the selected PCD will be able to launch its program, and that the properly speaking communication session with the reader will be possible.

The invention describes, first, a method for selecting a contactless electronic device among at least two, each comprising at least one item of visual information in an internal memory, by means of a contactless electronic terminal, this terminal being provided with a display means and an entry means. The method comprises at least the following steps:
supply of all or some of the contactless electronic devices through an electromagnetic field produced by the electronic terminal,
initialisation of each of the electronic devices,
establishment, by each of the electronic devices, of a connection with the electronic terminal,
sending, by each of the electronic devices, of the visual information items to the terminal,
display, by the terminal, of the visual information items received, on the display means,
selection, by the user, of one of the visual information items displayed by means of the entry means.

During said establishment step, the connections with each of the electronic devices can be made in parallel with one another, or sequentially one after the other.

The invention describes, secondly, a contactless electronic device comprising at least one memory, a processing unit, a display means and an entry means. This device has means configured for
establishing at least two contactless connections, with two distinct communicating electronic devices,
receiving, from each of these two communicating electronic devices, at least one of the visual information items,
displaying said visual information item on said display means,
receiving, through said entry means, an information item referred to as “selection information”,
sending a signal to at least one of said electronic devices.

Other features and advantages of the invention will emerge clearly from the description thereof that is given thereof below, by way of indication and in no way limitatively, with reference to the accompanying drawings, in which:

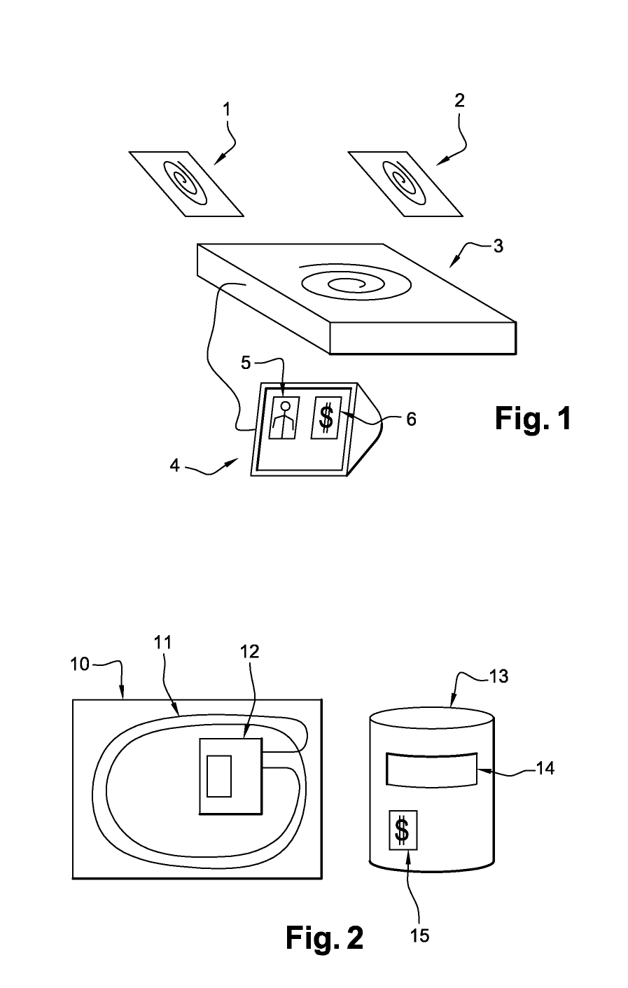

FIG. 1 shows a system comprising two PCDs, and a reader according to the invention.

FIG. 2 shows a PCD according to the invention.

In FIG. 1, two passive contactless devices (PCDs) 1 and 2 can be seen. These two PCDs are shown in the form of a contactless chip card.

These two PCDs 1 and 2 are in the field of action of a contactless reader 3. This reader emits an electromagnetic field able to supply the PCDs and has the means necessary for establishing a communication with each of them.

According to the invention, each of the PCDs, on receiving said electromagnetic field, starts up its electronic component and establishes a communication with the reader.

In an advantageous embodiment, this establishment takes place sequentially. That is to say, on reception of a communication request by one of the two PCDs, the reader establishes the communication and temporarily ignores the second request.

Each of the PCDs 1, 2, 10 is composed of at least an antenna 11 and an electronic component 12.

This electronic component (generally referred to as a “chip”) comprises at least one computing unit and a memory 13.

This memory 13 comprises at least one program 14, and a visual information item 15 according to the invention.

A visual information item according to the invention is a displayable element recognisable by the user. Advantageously, this information item is in the form of an “image” file, for example a photograph or a drawing.

In a preferred embodiment of the invention, this visual information item can be managed by the user. In this embodiment, the user may, according to defined conditions, load or modify this visual information item. For example, in the case of contactless bank cards, the user, in the presence of an employee of the bank, and going to a bank branch, may request to modify this visual information item in order to provide an image of his choice, and load it.

One particular embodiment provides for a PCD to be able to contain several visual information items and that the choice of the information items to be used is done randomly, at the time of transmission.

This memory may advantageously comprise an operating system distinct from said program 14.

This memory may be distributed in different physical memories, and in particular the operating system may be situated in a non-rewritable memory (referred to as ROM, standing for “Read Only Memory”), whereas the visual information items 15 may advantageously be stored in a rewritable memory.

Once the reader 3 has established at least one connection with a PCD, it awaits therefrom the visual information items according to the invention.

On reception of these visual information items, the reader puts the PCD “on standby”. This putting on standby may be done by means known to persons skilled in the art, or may advantageously be done by the non-sending of information expected by the PCD in the context of the standard communication protocol.

The same operation is thus performed with all the PCDs active in the electromagnetic field of the reader.

Once the reader has obtained all the visual information items 5, 6, it displays them on a display device 4. In FIG. 1, this display device is a touch screen connected to the reader 3. In a particularly advantageous embodiment of the invention, this display means may be completely integrated in the reader.

Once those information items 5, 6 are displayed, the reader awaits a selection from the user. This selection is done by an entry means. In the system of FIG. 1, the display device 4 being of the touch type, the entry is done via this same device. In a broader embodiment, any entry means known to persons skilled in the art may be used, in particular a keypad, a pointing device, etc. This selection produces data called “selection information”. This data is transmitted from the entry means to the computing unit.

According to the visual information items selected by the user via the entry means, the reader selects the corresponding PCD and gives it the possibility of pursuing the normal course of its execution, namely the launch of its program.

The other PCDs do not launch their program. This may be done either by sending them information in this regard (for example a dedicated message, or an error message), or by leaving them “on standby”.

1. A method for selecting a contactless electronic device among at least two, each comprising, in an internal memory, at least one item of visual information, by means of a contactless electronic terminal, said terminal being provided with a display means and an entry means, comprising:
supplying energy to at least some of the contactless electronic devices through an electromagnetic field produced by said electronic terminal,
initializing each of the supplies electronic devices,
establishing, by each of the supplied electronic devices, a connection with the electronic terminal,
sending, by each of the supplied electronic devices, the visual information item to the terminal,
displaying, by the terminal, the visual information item received, on the display means, and
selecting, by a user, one of said visual information items displayed by means of the entry means.

2. A method according to claim 1, wherein, during said establishing step, said connections with each of said electronic devices are made in parallel with one another.

3. A method according to claim 1, wherein, during said establishing step, said connections with each of said electronic devices are done sequentially one after the other.

4. A contactless electronic device comprising at least one memory, a processing unit, a display means and an entry means, wherein the contactless electronic device is configured for:
establishing at least two contactless connections, with two distinct communicating electronic devices,
receiving, from each of said two communicating electronic devices, at least one visual information item,
displaying said visual information item on said display means,
receiving, through said entry means, selection information, and
sending a signal to at least one of said electronic devices, based on the received selection information.
